(19) United States
(12) Patent Application Publication
(10) Pub. No.: US 2024/0182269 A1
(43) Pub. Date: Jun. 6, 2024

(54) ELEVATOR SYSTEM AND ELEVATOR DOOR CONTROL METHOD

(71) Applicant: Inventio AG, Hergiswil (CH)

(72) Inventor: Valerio Villa, Colverde (IT)

(21) Appl. No.: 18/551,889

(22) PCT Filed: Mar. 31, 2022
(86) PCT No.: PCT/EP2022/058514

§ 371 Date: Sep. 22, 2023

(30) Foreign Application Priority Data
Mar. 31, 2021 (EP) 21166226.7

(51) Int. Cl. B66B 13/14; B66B 13/12; B66B 13/16

(52) U.S. Cl. CPC B66B 13/146; B66B 13/125; B66B 13/165

(57) ABSTRACT

An elevator system includes: a car traveling in an elevator shaft; a car door arranged on the car; at least one shaft door arranged on a door opening of the elevator shaft; a shaft door locking device, in particular comprising a shaft door drive, for unlocking and/or closing and/or opening the shaft door; a shaft door sensor arranged on the shaft door and a car door signal transmitter arranged on the car door; and a shaft door control unit operatively connected to the shaft door sensor, the shaft door control unit directly actuating the shaft door locking device when a car door signal of the car door signal transmitter is received by the shaft door sensor.

### FIELD

The invention relates to an elevator system having a shaft door control unit which can directly control a shaft door locking device to unlock and/or open and/or close this shaft door.

### BACKGROUND

Elevator systems usually comprise an elevator car which can travel in an elevator shaft and which has a car door. A car door drive is arranged on the car and is provided for opening and closing the car door. Moreover, the elevator shaft has multiple door openings arranged one above the other, with a shaft door arranged at each opening. If the car stops at one of these shaft doors and/or is positioned there, the car door is usually mechanically coupled to the shaft door by means of a coupling device provided on the car door. Accordingly, the shaft door is passively unlocked/opened/closed. This means that both the car door and the shaft door are unlocked/closed exclusively by means of the car door drive. This approach was seemingly arrived at because no control electronics were mounted in shaft doors, and an active unlocking of the shaft door was thus not an option. The mounting of control electronics on each of the shaft doors would have unduly increased the costs for the elevator system.

Due to the technological development of electronics and drives, in particular communication electronics and electric motors, a solution with interesting cost effectiveness now exists in which both the car door and the shaft door comprise a locking device exclusively for unlocking/opening/closing the given door. Accordingly, the need for a mechanically vulnerable coupling which unlocks/opens/closes the shaft door as a result of the opening movement generated by the car door drive, is reduced. Nevertheless, it must be ensured that both the car door and the shaft door can only carry out an opening movement when the car door is positioned at the shaft door and the car is accessible from the building floor to passengers when both the shaft door is open and the car door is open.

### SUMMARY

It is therefore an object of the invention to develop an elevator system which enables a necessary degree of safety when the shaft door can be unlocked or opened or closed by a shaft door locking device arranged on the shaft door itself.

The object is achieved by an elevator system having a car which can travel in an elevator shaft, a car door arranged on the car, at least one shaft door arranged at a door opening of the elevator shaft, a shaft door locking device, in particular comprising a shaft door drive, to unlock/close/open the shaft door, a shaft door sensor arranged on the shaft door, and a car door signal transmitter which is arranged on the car door, and a shaft door control unit which is operatively connected to the shaft door sensor, wherein the shaft door locking device can be directly actuated by means of the shaft door control unit when the shaft door sensor receives a car door signal of the car door signal transmitter.

The object is also achieved by means of a method for controlling an elevator system comprising a car door and a shaft door, the method comprising the following method steps:
generating a car door signal by means of a car door signal transmitter arranged on the car door,
receiving the car door signal by means of a shaft door sensor arranged on the shaft door, wherein the reception of the car door signal confirms the presence of the car door on the shaft door,
transmitting the car door signal to a shaft door control unit for unlocking/opening/closing the shaft door,
directly actuating a shaft door locking device, in particular a shaft door drive of the shaft door locking device, by means of the shaft door control unit, for the purpose of unlocking/opening/closing the shaft door when the car door signal is present.

The invention is based on the finding that, in the case of an arrangement of such a shaft door locking device on the shaft door without a mechanical coupling, it must be ensured that the shaft door can be opened in normal operation solely when the car door is positioned at this shaft door. In this context, normal operation means that the car is in an operating state which enables passengers or goods to be transported between different floors.

The shaft door sensor is arranged on the shaft door in such a way that the car door signal generated by the car door signal transmitter can be received by the shaft door sensor, wherein the shaft door sensor in the elevator shaft is or can also be fixed or is or can also be arranged on an elevator wall laterally delimiting the elevator shaft. In particular, the shaft door sensor can be or is arranged or can be or is fixed directly on the shaft door or on the elevator wall delimiting the elevator shaft, on which elevator wall the shaft door is arranged.

A car door signal can be generated by the car door signal transmitter arranged on the car door. This car door signal can be received by the shaft door sensor when the car is positioned at the shaft door. The car door signal is transmitted to the shaft door control unit or is transmittable to the shaft door control unit. The transmission of the information indicating that the car door signal is received from the shaft door sensor is accordingly a prerequisite for unlocking and/or opening the shaft door, such that unlocking and/or opening can be directly implemented by the shaft door locking device. Accordingly, with this manner of ensuring the presence of the car when the shaft door is opened, the safety of persons located on the building floor is ensured.

A shaft door locking device as described above and below can consist of a shaft door lock and/or an active shaft door drive.

In one embodiment, the shaft door locking device consists only of a shaft door lock, wherein the shaft door can be blocked by the shaft door lock in a closed state.

Advantageously, the shaft door is designed such that the shaft door lock can block the shaft door in a closed state to provide a fail-safe in the event of failure. This means that the shaft door lock is designed so that it blocks the closed shaft door even if the energy supply fails. This can be implemented, for example, with a bolt moved downwards by gravity. This bolt can be actively held against gravity in a second, non-blocking state by energizing an electromagnet, for example. Furthermore, the bolt and the door can be designed such that the bolt is prevented from assuming the blocking state in a non-closed state of the door by the door leaf. The bolt can therefore only be in the state in which it locks the shaft door when the shaft door is closed. If the two described states (blocking/non-blocking) are monitored by a sensor, and the sensor determines the blocking state, a closed shaft door can be detected with certainty, and the car can be moved. In all other states (not-blocked, or no signal (failure of the sensor), the movement of the car is blocked. In this embodiment, the shaft door lock, i.e., for example, the electromagnet and the sensor, can be unlocked by direct actuation of the shaft door control unit when a car door signal of the car door signal transmitter is received by the shaft door sensor. It is advantageous that the shaft door can be unlocked solely when the car is positioned at the shaft door. Accordingly, an opening of the shaft door is not made possible if the car is not positioned at the shaft door. This consequently ensures the safety of persons located on the building floor, in particular if a person attempts to manually move the at least one door leaf of the shaft door manually, i.e., by hand, from its closed position in the direction of its open position.

In a further embodiment, the shaft door locking device consists only of a shaft door drive. In this embodiment, each of the shaft doors therefore comprises its own shaft door drive. The shaft door drive blocks the opening of the shaft door; and in a second state, it actively carries out the opening or closing of the shaft door. The shaft door drive thus acts as a shaft door locking device. The shaft door drive can be unlocked by a direct actuation of the shaft door control unit when a car door signal of the car door signal transmitter is received by the shaft door sensor—that is, it can be switched out of the blocking state into the moving state. It is advantageous in this case that the shaft door can be unlocked solely if the car is positioned at the shaft door. Accordingly, an opening of the shaft door is not made possible if the car is not positioned at the shaft door. This consequently ensures the safety of persons located on the building floor, in particular if a person attempts to manually move the at least one door leaf of the shaft door manually, i.e., by hand, from its closed position in the direction of its open position.

In a further embodiment, the shaft door locking device consists of a combination of the two previously mentioned embodiments with a bolt and shaft door drive.

In one embodiment of the elevator system, the shaft door sensor is arranged on the shaft door and the car door signal transmitter is arranged on the car door in such a way that the car door signal can be received by the shaft door sensor when the car door is positioned in a door opening zone of the shaft door.

The car and/or the car door is then considered to be positioned in such a door opening zone if the car can be accessed from the building floor with the shaft and car doors opened, specifically in such a way that a fall into the elevator shaft from the building floor is made impossible, as pursuant to safety regulations in force. Accordingly, a height difference between the floor of the car and the building floor surface is permitted to a certain extent. In the case of, for example, a power failure and a car accordingly immobilized in the elevator shaft, persons can be evacuated from the car through the opened shaft door and car door, even if the floor surface of the car is not flush with the building floor surface.

In one embodiment of the elevator system, the car door signal transmitter is designed as a magnet, in particular as a permanent magnet. It is advantageous that a car door signal generated by means of the car door signal transmitter can be received by the shaft door sensor independently of prevailing conditions in the elevator shaft. By way of example, such a magnet is substantially insensitive to extreme heat or cold, contamination, or high air humidity. In this embodiment, the shaft door sensor is designed as a magnetic field detector, such that this arrangement of the car in the vicinity of the shaft door is detected.

An embodiment of the elevator system comprises a car door drive for closing/opening/unlocking the car door and a car door sensor, which car door sensor is arranged on the car door, and a shaft door signal transmitter, which shaft door signal transmitter is arranged on the shaft door, and a car door control unit operatively connected to the car door sensor, by means of which car door control unit the car door drive can be directly actuated to close/open the car door when a shaft door signal of the shaft door signal transmitter is received by the car door sensor.

An embodiment of the method comprises the following method steps:
generating a shaft door signal by means of a shaft door signal transmitter arranged on the shaft door,
receiving the shaft door signal by means of a car door sensor arranged on the car door,
transmitting the shaft door signal to a car door control unit to open/close the car door when the shaft door signal is present.

The car door sensor is thus arranged or fixed on the car door or can be arranged/fixed in the surroundings of the car door on the car, such that the shaft door signal generated by the shaft door signal transmitter can be received by the car door sensor.

In this way, it is possible, on the one hand, to recognize by means of the car door signal that the car is positioned at the shaft door, and, on the other hand, that the shaft door is positioned at the car. Accordingly, it is clear that improved safety can be achieved by means of such an arrangement since each of the sensors and/or signal transmitters has a certain fault or failure probability. Accordingly, for a given failure probability of the car door sensor or the shaft door sensor, it can be determined whether the car is actually positioned at the shaft door which is detected by the car door sensor. In other words, increased safety is provided when both the car door signal can be received by the shaft door sensor, and the shaft door signal can be received by the car door sensor simultaneously. Furthermore, the shaft door signal can include an identification feature in order to further increase the safety.

An embodiment of the method comprises the following method steps:
transmitting the shaft door signal from the car door sensor to the shaft door control unit,
directly actuating the shaft door locking device by the shaft door control unit to open/close the shaft door when the car door signal and the shaft door signal are present.

Accordingly, the shaft door can only be unlocked/opened/closed by means of the shaft door locking device if the car door sensor receives the shaft door signal generated by the shaft door signal transmitter in addition to the car door signal. Preferably, the shaft door signal has the identification feature named above, such that the shaft door locking device can only perform an unlocking/opening/closing of the shaft door if the shaft door signal of the same shaft door is received by the car door sensor.

In one embodiment of the elevator system, the car door control unit is operatively connected to the shaft door control unit, and the shaft door locking device can be directly actuated by the shaft door control unit to unlock/close/open the shaft door upon the receipt of a shaft door signal triggered by the shaft door signal transmitter at the car door sensor. Such an operative connection allows verifying that the car door is positioned at the shaft door to be opened. Accordingly, the shaft door is only openable if both the shaft door signal and the car door signal indicate that the car door is positioned at the shaft door. Accordingly, safety is increased, since one of the car door signals and the shaft door signal can be faulty.

In one embodiment of the elevator system, the shaft door control unit and the car door control unit are connected or connectable to one another in a wireless manner. The car door control unit can be arranged directly on the car door and thus on the car, and the shaft door control unit can be arranged directly on the shaft door. Additional safety can be provided in this way.

One embodiment of the elevator system comprises a car control unit, an absolute position system, by means of which absolute position system a position signal can be transmitted to the shaft door control unit, and/or a brake system for arresting the car in the elevator shaft, by means of which brake system an arrest signal can be transmitted to the car control unit. To further increase safety, the position signal and/or the arrest signal can be evaluated in such a way that it is possible to determine that the car is arrested within the elevator shaft. That is to say, if the car door is present at the shaft door, and in particular a car door signal is detected by the shaft door sensor, and optionally moreover a shaft door signal is detected by the car door sensor, the position of the car can be securely determined additionally by means of the position signal and/or the arrest signal.

### DESCRIPTION OF THE DRAWINGS

The invention is explained in greater detail below with reference to drawings. In the drawings:

FIG. 1: shows an elevator system having a car which can travel in the elevator system; and

FIG. 2: shows a schematic illustration of the elevator system shown in FIG. 1.

### DETAILED DESCRIPTION

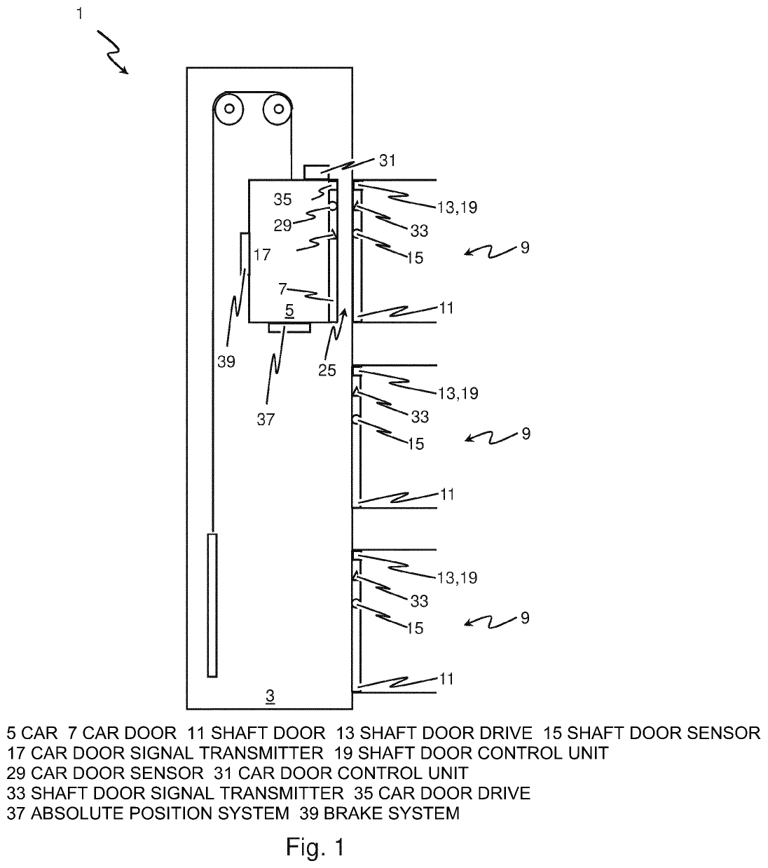

FIG. 1 is an elevator system 1 arranged typically inside a building. The elevator system 1 comprises a car 5 which can travel in a usually vertically-oriented elevator shaft 3. A car door 7 is arranged on the car 5. The elevator shaft 3 has multiple door openings 9 arranged one above the other, in order to enable access to individual floors of the building. A shaft door 11 is arranged at each of these door openings 9. If the car 5 and/or the car door 7 arranged on the car 5 is positioned at one of these shaft doors 11, the car 5 can be accessed from the building floor of the shaft door 11 when the car door 7 is open and the shaft door 11 is open.

The car door 7 has a car door drive 35 and a car door signal transmitter 17. Each of the shaft doors 11 has a shaft door drive 13 that functions as a shaft door locking device. A shaft door control unit 19 is assigned to each of these shaft door drives 13, and the shaft door control unit 19 can directly actuate the shaft door drive 13 assigned to it. By means of the actuation of the shaft door drive 13, the shaft door 11 assigned to the shaft door drive 13 can be unlocked and/or opened and closed.

A shaft door sensor 15 is arranged on each of the shaft doors 11 in such a way that the car door signal generated by the car door signal transmitter 17 can be received by the shaft door sensor 15—given a corresponding position of the car 5 in a door opening zone 25. Accordingly, the shaft door sensor 15 of each of the shaft doors 11 is operatively connected to the shaft door control unit 19 of the same shaft door 11.

The car door signal transmitter 17, which is preferably designed as a magnet, in particular as a permanent magnet, causes a car door signal to be generated, which is consequently receivable by the shaft door sensor 15 if the car 5 is positioned at the shaft door 11 assigned to the shaft door sensor 15. The shaft door sensor 15 is operatively connected to the shaft door control unit 19, such that the car door signal can be transmitted or is transmitted to the shaft door control unit 19.

Furthermore, the elevator system 1 comprises a car door control unit 31, preferably fixed to the car 5, and can comprise a car door sensor 29 which is arranged on the car 5 and/or on the car door 7. A shaft door signal generated by a shaft door signal transmitter 33 can be received by the car door sensor 29. Such a shaft door signal transmitter 33 assigned to this shaft door 11 can be arranged on each shaft door 11. Furthermore, the car 5 has an absolute position system 37, which is designed, for example, as a laser positioning system, and the car has a brake system 39.

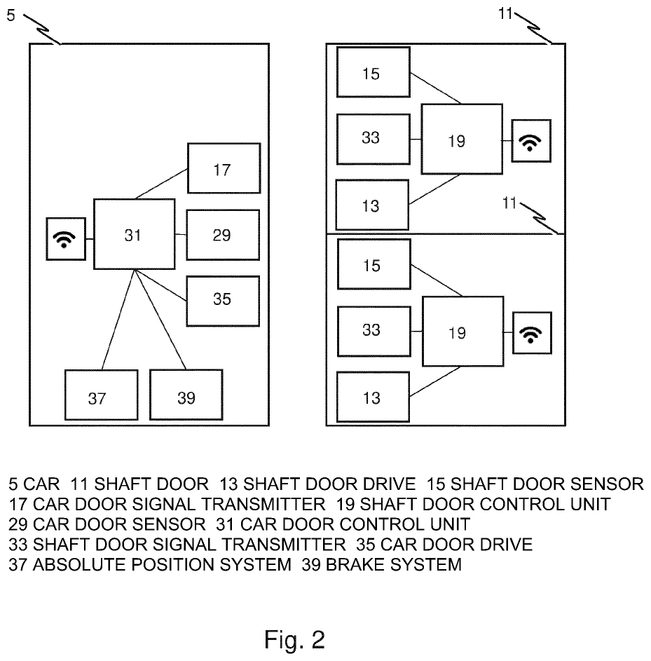

FIG. 2 is a schematic illustration of the elevator system 1 shown in FIG. 1. The schematic illustration shows the shaft door control unit 19 and the car door control unit 31. The shaft door control unit 19 and the car door control unit 31 are operatively connected to one another, preferably wirelessly. In addition, the absolute position system 37 and the brake system 39 used to arrest the car 5 are shown. The absolute position system 37 generates a position signal constantly or periodically. The position signal indicates the location of the car 5 in the elevator shaft 3. The brake system 39 comprising an arresting brake generates an arrest signal in the event that the car 5 is arrested in the elevator shaft 3. Accordingly, the arrest signal is generated if the arresting brake is blocked and consequently the car 5 in the elevator shaft 3 is not able to travel in the elevator shaft.

The position signal can be transmitted to the shaft door control unit 19. The arrest signal can be transmitted to the car door control unit 31. The shaft door control unit 19 can receive and evaluate the car door signal, the position signal and the arrest signal. If the evaluation reveals that the car 5 is both positioned and arrested at the shaft door 11 assigned to the shaft door control unit 19, the shaft door drive 13 assigned to the shaft door control unit 19 can be actuated directly to open the shaft door 11.

In addition, the car door control unit 31 can transmit the shaft door signal to the shaft door control unit 19 for further evaluation. If the evaluation reveals that the shaft door signal can be assigned to the shaft door 11 of the shaft door drive 13 to be actuated, greater safety can be achieved by means of such an evaluation.

In accordance with the provisions of the patent statutes, the present invention has been described in what is considered to represent its preferred embodiment. However, it should be noted that the invention can be practiced otherwise than as specifically illustrated and described without departing from its spirit or scope.

1-11. (canceled)

12. An elevator system comprising:
a car traveling in an elevator shaft;
a car door arranged on the car;
a shaft door arranged on a door opening of the elevator shaft;
a shaft door locking device including a shaft door drive adapted to at least one of unlock, close and open the shaft door;
a shaft door sensor arranged on the shaft door and a car door signal transmitter arranged on the car door; and
a shaft door control unit operatively connected to the shaft door sensor, the shaft door control unit directly actuating the shaft door locking device when a car door signal generated by the car door signal transmitter is received by the shaft door sensor.

13. The elevator system according to claim 12 wherein the car door signal generated by the car door signal transmitter is received by the shaft door sensor only when the car door is positioned in a door opening zone of the shaft door.

14. The elevator system according to claim 12 wherein the car door signal transmitter is a magnet.

15. The elevator system according to claim 14 wherein the car door signal transmitter is a permanent magnet.

16. The elevator system according to claim 12 including a car door drive adapted to at least one of close, open and unlock the car door, a car door sensor arranged on the car door, a shaft door signal transmitter arranged on the shaft door, and a car door control unit operatively connected to the car door sensor and adapted to directly actuate the car door drive to at least one of close, open and unlock the car door when the car door sensor receives a shaft door signal generated by the shaft door signal transmitter.

17. The elevator system according to claim 16 wherein the car door control unit is operatively connected to the shaft door control unit, and the shaft door locking device is directly actuated by the shaft door control unit to at least one of unlock, close and open the shaft door when the car door sensor receives the shaft door signal triggered by the shaft door signal transmitter.

18. The elevator system according to claim 16 wherein the shaft door control unit and the car door control unit are wirelessly connected.

19. The elevator system according to claim 16 including an absolute position system generating a position signal representing a position of the car in the elevator shaft and transmitting the position signal to the shaft door control unit, and further including a brake system adapted to arrest the car in the elevator shaft, the brake system transmitting an arrest signal to the car door control unit when the car is arrested.

20. The elevator system according to claim 19 wherein the shaft door control unit simultaneously evaluates at least two of the arrest signal, the position signal, the car door signal, and the shaft door signal.

21. A method for controlling a car door and a shaft door of an elevator system, the method comprising the steps of:
generating a car door signal from a car door signal transmitter arranged on the car door;
receiving the car door signal by a shaft door sensor arranged on the shaft door;
transmitting the received car door signal to a shaft door control unit to at least one of open, close and unlock the shaft door; and
directly actuating a shaft door locking device with the shaft door control unit to at least one of unlock, open and close the shaft door when the cabin door signal is present at the shaft door control unit.

22. The method according to claim 21 further comprising the method steps of:
generating a shaft door signal by shaft door signal transmitter arranged on the shaft door;
receiving the shaft door signal by a car door sensor arranged on the car door; and
transmitting the received shaft door signal to a car door control unit to at least one of open, close and unlock the car door when the shaft door signal is present at the car door control unit.

23. The method according to claim 22 further comprising the method steps of:
transmitting the shaft door signal from the car door sensor to the shaft door control unit; and
directly actuating the shaft door locking device by the shaft door control unit to at least one of unlock, open and close the shaft door when the car door signal and the shaft door signal are present at the shaft door control unit.
